(19) United States
(12) Patent Application Publication
(10) Pub. No.: US 2006/0080407 A1
(43) Pub. Date: Apr. 13, 2006

(54) Multimedia session establishment in a user entity having audio floor control

(75) Inventor: Ganesan Rengaraju, Oak Park, IL (US)

Correspondence Address: LAW OFFICES OF CHARLES W. BETHARDS, LLP, P.O. BOX 1622, COLLEYVILLE, TX, 76034, US

(73) Assignee: MOTOROLA, INC.

(21) Appl. No.: 10/963,145

(22) Filed: Oct. 12, 2004

(51) Int. Cl. H04N 7/18

(52) U.S. Cl. 709/219; 725/78

(57) ABSTRACT

A method (500) and apparatus (301) are described for establishing a video information stream (102) and a corresponding audio information stream (103) between an originating communication unit (110) having floor control and a target communication unit (120). A call is initiated to obtain floor control and a media path is established for transferring the video and audio information streams. The video information stream is established in a full duplex mode and the audio information stream is established in a half duplex mode using a Session Initiation Protocol (SIP). The call may include a peer to peer or a group call.

### FIELD OF THE INVENTION

The present invention relates in general to communication systems and more specifically to methods for establishing multimedia sessions between communication units in such systems.

### BACKGROUND OF THE INVENTION

Group calls have historically been an important feature in radio dispatch services such as police and rescue services. More recently, such features have been made available to communication units in communication networks such as Radio Access Networks (RANs), operated by some service providers in connection with various enhanced services. In addition to enhanced services available within the network infrastructure, communication units are now being provided with additional features such as cameras and the like capable of dramatically enhancing the communication experience for users.

Some networks are based on the Integrated Digital Enhanced Network developed by Motorola, Inc. of Schaumburg, Ill. and use radio spectrum, for example, in the 800 MHz (Megahertz)range. This network provides for example, one or more of normal cell phone voice communications, messaging services such as broadcast services, text messaging, electronic amial (e-mail), data services such as wireless Internet and private data networks, and digital two-way radio or dispatch services such as one-to-one and group communication. Group calls, noted above, typically rely on a Push-To-Talk (PTT) call initiation commonly used in dispatch radio systems requiring a user or speaker in an active communication to press a talk button before talking and to release the talk button when finished talking to relinquish the floor and to allow another participant in the call to obtain the floor.

In a PTT communication, audio floor control is typically established through a contention type protocol, that is, the first communication unit to activate the PTT button when the channel is free will be granted the channel and other communication units attempting to PTT when the floor is held or occupied by another will not be granted the channel. PTT communications are typically conducted using the Session Initiation Protocol (SIP) as described, for example, in Internet Engineering Task Force (IETF), Request For Comments (RFC) 2543, 3261, and 3265. It will be appreciated that for audio transmissions, a half duplex mode is generally established such that only one communication unit can “talk” or generate outbound voice traffic, at one time and other communication units must listen during the talking interval.

In order to take advantage of the possibilities presented by communication unit technology such as cameras and the like capable of enhancing the communication experience, the readily available half duplex transmission mode may not be suitable for video transmission.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 is a diagram illustrating an exemplary peer-to-peer Push to Video (PTV) call environment in accordance with various exemplary embodiments;

FIG. 2 is a diagram illustrating an exemplary PTV group call environment in accordance with various exemplary embodiments;

FIG. 3 is a diagram illustrating an exemplary apparatus and components thereof capable of participating in a PTV call in accordance with various exemplary embodiments;

FIG. 4 is a diagram further illustrating exemplary components associated with a PTV client in accordance with various exemplary embodiments; and

FIG. 5 is a flow chart illustrating an exemplary procedure associated with establishing a peer to peer or group PTV call in accordance with various exemplary embodiments.

### DETAILED DESCRIPTION

In overview, the present disclosure concerns the establishment of a peer to peer or group call between an originating wireless device such as a stationary or fixed wireless transceiver, wireless communications unit, User Equipment or Entity (UE), or an originating wired device having an Internet connection, and the like in a Radio Access Network (RAN) which supports packet switched data communication, and one or more target communication units in the RAN. Further, a method and apparatus for establishing a Push to Video (PTV) call between the originating communication unit and one or more of the target communication units and allowing video to be transferred therebetween such that the video information is transferred in a full duplex mode and the audio information is transferred in a half duplex mode is described. It should be noted that conventional methods of establishing group calls or private, that is, peer-to-peer calls, do not presently address the special needs of transferring video associated with telephones or the like capable of transmitting video along with audio in the RAN.

In accordance with various exemplary embodiments, the present invention allows a full duplex video channel and a half duplex audio channel to be established between the originating communication unit and one or more target communication units when the originating communication unit initiates a PTV action such as pressing a PTV button in a manner similar to a conventional PTT activation. It will be appreciated that the inventive concepts discussed and described herein related to PTV in accordance with various exemplary embodiments, may be performed in a general purpose or dedicated device such as a communication unit having a general purpose or dedicated processor, a processor with appropriate software for performing a communication unit function, an application specific integrated circuit (ASIC), a digital signal processor (DSP), or the like, or various combinations thereof, as would be appreciated by one of ordinary skill. Memory devices may further be provisioned with routines and algorithms for carrying out various aspects of the invention which will be described in greater detail hereinafter.

It will further be appreciated that terms, such as communication unit or wireless communication unit generally refer to subscriber devices such as cellular or mobile phones, two-way radios, messaging devices, personal digital assistants, personal assignment pads, personal computers equipped for operation, a cellular handset or device, or the like, or equivalents thereof provided such units are arranged and constructed for operation in accordance with the various inventive concepts and principles embodied in, for example, exemplary communication units and methods capable of generating a video stream and operating in a PTV environment often under appropriate specifications, standards, and protocols as discussed and described herein.

The principles and concepts discussed and described may be particularly applicable to communication units, devices, and systems providing or facilitating packet based voice communications services or data or messaging services over wide area networks (WANs), such as conventional two way systems and devices, various cellular phone systems including analog and digital cellular, CDMA (code division multiple access) and variants thereof, GSM (Global System for Mobile communications), GPRS (General Packet Radio System), 2.5 G and 3G systems such as UMTS (Universal Mobile Telecommunication Service) systems, Integrated Digital Enhanced Networks and variants or evolutions thereof. Principles and concepts described herein may further be applied in devices or systems with short range communications capability normally referred to as W-LAN (Wireless-Local Area Network) capabilities, such as IEEE 802.11, Bluetooth, or Hiper-LAN and the like that preferably utilize CDMA, frequency hopping, orthogonal frequency division multiplexing, or TDMA (Time Division Multiple Access) access technologies and one or more of various networking protocols, such as TCP/IP (Transmission Control Protocol/Internet Protocol), IPX/SPX (Inter-Packet Exchange/Sequential Packet Exchange), Net BIOS (Network Basic Input Output System) or other protocol structures.

Further in accordance with various exemplary and alternative exemplary embodiments, the packet based RAN can include a Code Division Multiple Access (CDMA) RAN, a Global System Mobile (GSM) RAN, Universal Mobile Telecommunication System (UMTS) RAN, a Data Only (DO) RAN, a High Rate Packet Data Access (HRPDA) RAS, a Wireless Local Area Network (WLAN) RAN, or an Evolution Data Voice (EVDV) RAN. The exemplary RAN should support communications under the IP Multimedia (IM) core specifications, for example as outlined in the Third Generation Partnership Project (3GPP) Technical Specification (TS) 24.229 for communications using Session Initiation Protocol (SIP), Session Description Protocol (SDP) and variants thereof. It will be appreciated that other 3GPP specifications and standards may also be relevant herein. For example, in accordance with some exemplary embodiments, the invention may require devices such as video codecs and the like to be used which codecs will generally conform to specifications described in 3GPP TS 26.235 or the like. Further in accordance with various exemplary embodiments, the present invention can be implemented as a higher layer, such as application layer software application, in which case lower protocol layers, such as the data link layers, can be interchangeable without departing from the intended scope of the invention, provided they support packet switched communication.

It should be noted that in accordance with the above noted standards, such as 3GPP release 5 IMS specification TS 24.229, multimedia streams can be transmitted over RTP/UDP (Real Time Transfer Protocol/Universal Datagram Protocol (User Datagram Protocol)) and corresponding floor control is transmitted over RTCP/UDP (Real Time Transfer Control Protocol/UDP). In other documents, for example the Push to Talk over Cellular (PoC) specification draft, mechanisms are described for transmitting audio over IP networks. In the present version of the PoC specification however, the issue of multiple media streams is not addressed, although TS 24.229 describes that when multiple media such as audio and video are transmitted, each media stream needs one data path for payload and one path for control. Since carriers are increasingly concerned with saving data paths in order to efficiently utilize resources, the present invention provides further advantages in that only one control path is required for multiple streams such as an audio and video media stream. Thus, the present invention, although enabled by the IMS specification, is independent of PoC and its attendant limitations.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. The invention may further include a process with steps, procedures, or the like. Where a plurality of processes or steps are indicated, they may be performed in any order, unless expressly and necessarily limited to a particular order. Steps or processes that are not so limited may be performed in any order. In certain cases, these steps or processes may be repeated a number of time or may loop infinitely as required or until a particular event occurs or the like.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to various embodiments.

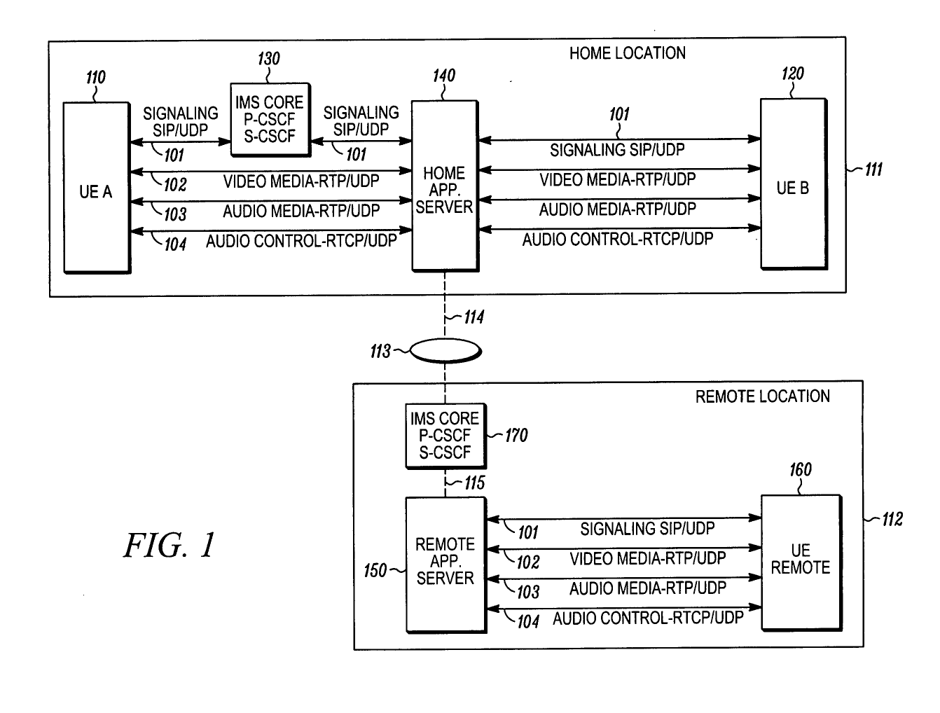

With reference to FIG. 1 an exemplary Push to Video (PTV) configuration is shown. An originating communication unit 110 associated with, for example, User Entity (UE) A, can engage in a bidirectional communication session with a target communication unit 120 associated, for example with UE B, within home location 111 wherein a video media stream 102 and an audio media stream 103 are established therebetween, for example in accordance with IMS (Internet protocol Multimedia Subsystem) and SIP procedures. It will be appreciated that communication unit 110 and 120 can refer to any communication device such as is commonly referred to in the art as a User Entity (UE). It will also be appreciated that the session can be conducted in connection with an Internet protocol Multimedia Subsystem (IMS) core 130 and can be established through, for example, a home application server 140 which can broadcast the audio and video streams to the target communication unit 120 or other units in the PTV call. The IMS core 130 acts as a Proxy-server Call State Control Function (CSCF), which is an initial interface (SIP Server) between the originating communication unit 110 and the IMS core 130. The address of the P-CSCF is discovered, for example, as part of the SM (Session Management) procedures involved with establishing IP connectivity. That is, the address of the P-CSCF may be provided during the PDP Context Activation process. Alternatively, the address may be resolved after the PDP (Packet Data Protocol) Context Activation process through the DHCP (Dynamic Host Configuration Protocol) Query/Response process. In accordance with DHCP and as generally known, the originating communication unit 110 will request an IP Address plus other variables in order to establish IP sessions.

Further in accordance with IMS and SIP procedures, during initial session establishment, the IMS core 130 can determine a set of media characteristics including a common codec or set of codecs using end-to-end message exchanges to determine the full scope of media characteristics. The session initiator, that is originating communication unit 110, makes the final determination of the codec or codecs to be used at least initially. It will be appreciated that changes to the media characteristics can be made during the session if they have already been included in the initial list of media characteristics and require no further resource allocations beyond, for example, the resources allocated during context activation. A session change can be initiated if additional resources are needed.

It will further be appreciated that in order to begin session negotiation, originating communication unit 110 can include its terminal capabilities including codecs, user preferences, bandwidth requirements, local port number assignments for possible media streams, and the like into an SDP payload to be included in a SIP INVITE message which is passed to the IMS core 130. It should be noted that a feature tag value can be set to, for example, “ptv.fullduplex” to indicate that the session will be a PTV session. If multiple media streams are presented, multiple codec choices can be offered for each stream. The IMS core 130 can examine the payload transmitted with the SIP INVITE message and if parameters are found which, for example, violate local policy the session initiation attempt can be rejected with information sufficient to allow the originating communication unit 110 to re-establish the session with new parameters (see, Internet Engineering Task Force (IETF), Request for Comments (RFC) 3261).

The IMS core 130 forwards the SIP INVITE message to the target communication unit 120 which then determines the complete set of codecs it is capable of supporting and further determines the intersection of this set and the set of codecs sent in the SIP INVITE message. For media streams not supported, the target communication unit 120 can construct an SDP with port assignments set to zero, otherwise, for streams that are supported a port assignment can be returned. The answer SDP can be returned to the IMS core 130 which can then authorize Quality of Service (QoS) resources for the assigned streams.

Once a packet switched call is set up, for example, using Session Initiation Protocol (SIP) messaging on a signaling channel 101 and through the IMS core 130 as noted above, a packet switched session can be conducted with the target communication unit 120 through the home application server 140. In addition to audio information transferred in the audio stream 103, video information can be transferred between the originating communication unit 110 and the target communication unit 120 through the video media stream 102 which includes a full duplex stream, that is, video information may be transferred both directions on the video media stream 102 at the same time. It should be noted the video media stream 102 is capable of generating a continuous stream of packet video data once the packet switched call is set up. The significance of full duplex video streaming is that both parties can transmit and receive each other's respective video information at the same time allowing, for example, real time videoconferencing, interactive gaming, or the like.

The audio media stream 103, as noted, is established in a half duplex mode since, according to floor control oriented group call protocols, only one speaker may be active at one time. It will be appreciated that through the use of Talk Permit Tones (TPT), peers or members of the group call can identify when it is possible to talk when the PTT or PTV button is pressed and a TPT is generated.

As can be seen and appreciated by one of ordinary skill in the art, four communications sockets 101-104 are required, one for the video stream, two for the audio stream and one socket for signaling and control. In accordance with various exemplary embodiments, the term socket as used herein can refer, for example, to a software interface, driver, operating system extension or the like, for handing the transfer and control streaming data, for example in accordance with a lower level protocol.

In accordance with embodiments involving calls within the home location 111, audio and video media stream establishment can proceed generally as noted above. However, if a call is placed to a UE outside the home location 111 of originating communication unit 110, such as to a remote location 112, the SIP INVITE message associated with call establishment can be redirected to a remote target communication unit 160 associated with a remote UE via a remote application server 150 using IP network connections 114 and 115 to an IP network 113. Further the initial call establishment negotiation as described above, can proceed with IMS core 130 communicating the contents of the SDP payload associated with the SIP INVITE message to an IMS core 170. After the contents are examined, the IMS core 170 can reject the initiation attempt if any of the parameters are in conflict with local policy. Otherwise the SDP payload and SIP INVITE are forwarded by the IMS core 170 to the remote target communication unit 160 which then can determine its own codec parameters, compare the parameters with parameters in the SIP INVITE and construct an SDP answer message with, as noted above, the port assignments for unsupported media streams set to zero and valid port assignments for supported media streams. The SDP answer is passed back to the originating communication unit 110. The negotiation process can continue until a final set of media streams are agreed upon.

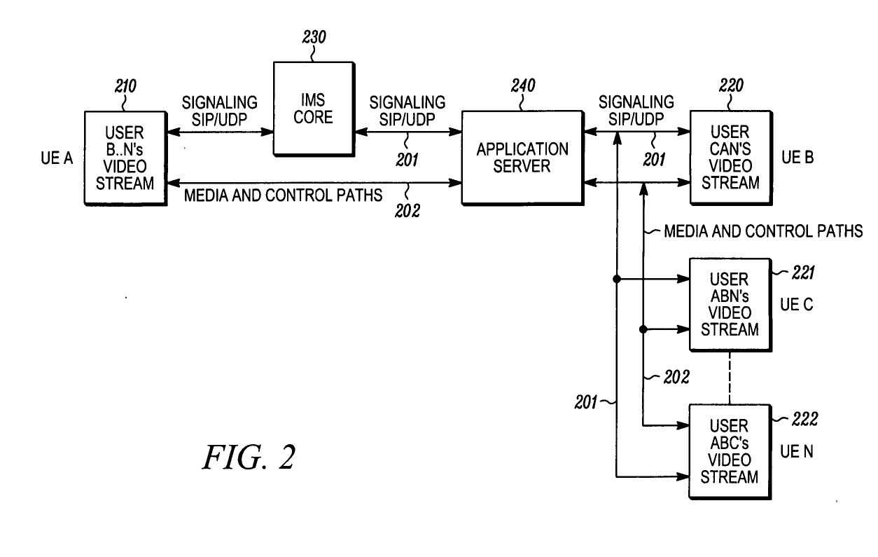

Referring to FIG. 2, an originating communication unit 210, similar to the originating communication unit 110 of FIG. 1 and associated with, for example, UE A, is configured to initiate a group call, for example, with some or all of target communication units 220, 221, and 222, associated with, for example, UE B, UE C, . . . , UE N. It will be appreciated that in accordance with accepted procedures, such as are, for example, specified in connection with SIP standards, a PTV call can be established and a video media stream and an audio media stream established when audio floor control is obtained. When the PTV button or the like activator is pressed or otherwise activated, the “To” field will contain a SIP Universal Resource Identifier (URI) for the group address or identity of UE A, UE B, and UE N and this can be passed to an IMS core 230, similar to the IMS core 130 described above. The IMS core 230 supplies the application server 240 with the URI, etc.

The application server 240 will resolve the individual addresses of the UEs associated with the URI, for example, from a List Management Services entity as will be appreciated by one of ordinary skill. The application server 240 can then generate individual SIP INVITE messages to the target UEs and conduct SIP exchanges therewith. Responses from each target UE can be forwarded to the originating communication unit 210 using SIP NOTIFY messages as would be appreciated by one of ordinary skill in the art. For simplicity, the video media stream and audio media stream and audio control portions, described above in connection with FIG. 1 for example as the video media stream 102, the audio media stream 103, and the audio control path 104, are combined in FIG. 2 as a media and control path 202.

It will also be appreciated that SIP signaling can be conducted using a SIP/UDP signaling channel 201 to moderate the group call, for example, by joining late users and inviting and joining new users and the like. Once floor control is established, the originating communication unit 210 will be in a TALK mode and the target communication units 220-222 will be in a LISTEN mode. As noted above, if the target UEs are in remote locations, then the SIP INVITE messages associated with establishing the call can be routed to the remote application servers associated with the remote locations of respective remote targets. Otherwise, for calls within an area served by the same local or home application server will proceed as described.

The video media stream portion of the media and control path 202 is established in a full duplex mode for the reasons set forth herein above, that is to conduct two way transfers of video, and the audio stream portion of the media and control path 202 is established in a half duplex mode for the reasons set forth herein above, that is ensure only one user talks at any one time. In a group call, the originating communication unit 210 and each of the target communication units 220-222 can experience full duplex video by sending and receiving a stream of video information to and from all or a select number of the other users and can send audio only when floor control is obtained. At other times, such as when floor control is not obtained, users can listen to the user having floor control while watching a video stream and, at the same time, sending a video stream if equipped with a camera and video processing and transmission capability. To accomplish the transfer of multiple video streams, it will be appreciated that the application server 240, for example, must mix or multiplex video streams from the target communication units 220-222 and synchronize the audio stream from the UE having floor control using approaches known to those of skill in the art and transfer the audio stream to participants. The application server 240 can multicast the multiplexed video streams to all UEs participating in the call using for example the group identifier or address or can otherwise direct the multiplexed video streams to session participants.

It will be appreciated that in accordance with various alternative exemplary embodiments, for example in a mixed mode group call environment, if one of the users is not equipped with a camera, or is not equipped with a display capable of displaying a video stream from another user, or the like, it would be desirable for that user to have at least the capability to transmit and receive audio. In still other exemplary embodiments, a user interface display window can be configured with display windows for each UE in the group call in a split screen mode. The window associated with the UE having floor control can be configured to blink or can be highlighted or the like to provide an indication of floor control to other UEs. In addition, a user can have the ability to select one of the display windows to be displayed exclusive of the other windows, can block one of the windows from display, or can block outgoing video associated with its own unit, or the like.

It should be noted that the initial session negotiation using SIP INVITE messages exchanged with the IMS core 230 can be established in a similar manner as described above when the group call target UEs are within a home location. When some or the entire group call target UEs are within one or more remote locations the IMS core 230 can forward the SIP INVITE to the IMS core serving the location or locations where the remote UE or UEs are situated.

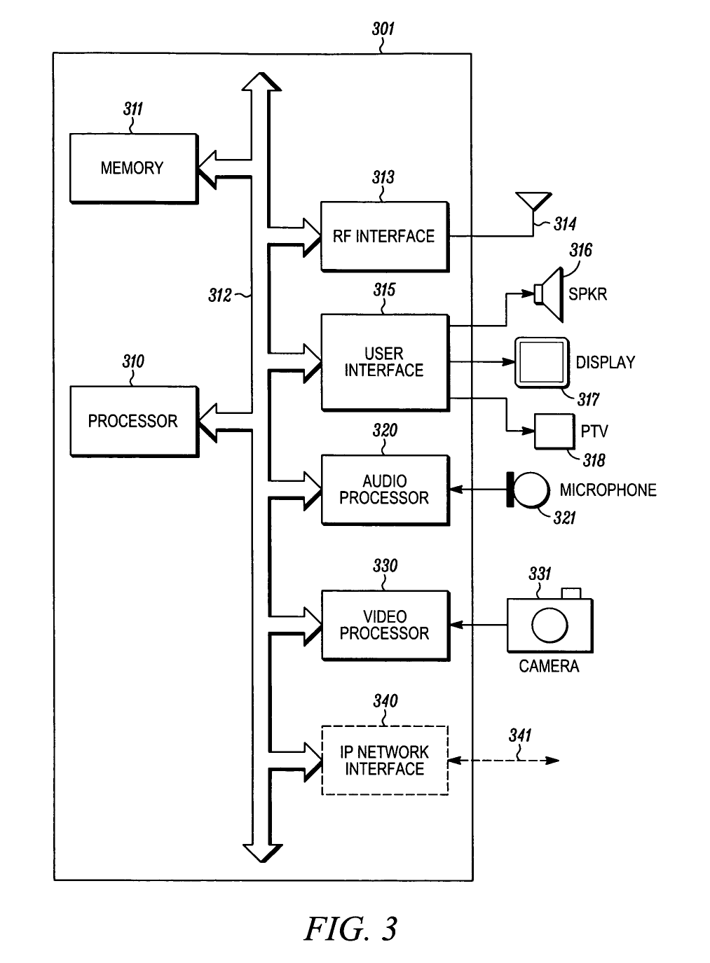

A typical communication unit used for conducting peer to peer and group calls in connection with various exemplary embodiments is depicted in a device 301 shown in FIG. 3. A processor 310, which may be a general purpose processor, or a custom configured processor, Application Specific Integrated Circuit (ASIC), or the like is coupled through a bus 312 to a memory 311, which may be a Random Access Memory (RAM) or the like, and as will be appreciated by one of ordinary skill in the art, can be resident within the processor, external to the processor, or may be external and work in connection with an internal or resident memory associated with the processor 310. The device 301 also includes an RF (radio frequency) transceiver or interface 313 with an antenna 314 capable of receiving signals over an air interface and transmitting signals over an air interface under control of, for example the processor 310 through the bus 312, such that the device 301 can connect with and receive and transmit information such as video and audio stream information with the RAN and other devices connected thereto such as user devices participating in a peer to peer or a group call. The device 301 may further be configured with an IP network interface 340 with a connection 341 to an IP network such as an Internet network for sending and receiving for example, AMR (Adaptive Multi-Rate) and MPEG (Moving Picture Experts Group) payloads in accordance with RTP.

The device 301 includes a user interface 315 having an audio transducer such as a speaker 316, a display such as a display 317 configured to be capable of displaying video such as an LCD display or the like, and a button or other activator such as PTV activator 318. As noted above, the display 317 can be configured to display several sub windows corresponding to other UEs involved in the call or session with individual video streams being directed to respective sub windows for display. If the call or session is a peer to peer call, the split window function will not be necessary. In accordance with some exemplary embodiments, it will be appreciated that in addition to or aside from a button or mechanical activator, PTV call initiation may be accomplished in many other ways including voice activated or perhaps video activated PTV. As will be described in greater detail herein after, the device 301 includes an audio processor 320 which is coupled to microphone 321 for generating voice information for transfer in an audio media stream or the like. The device 301 further includes a video processor 330 coupled to camera 331 for generating video information for transfer in a video media stream or the like as will be described in greater detail hereinafter.

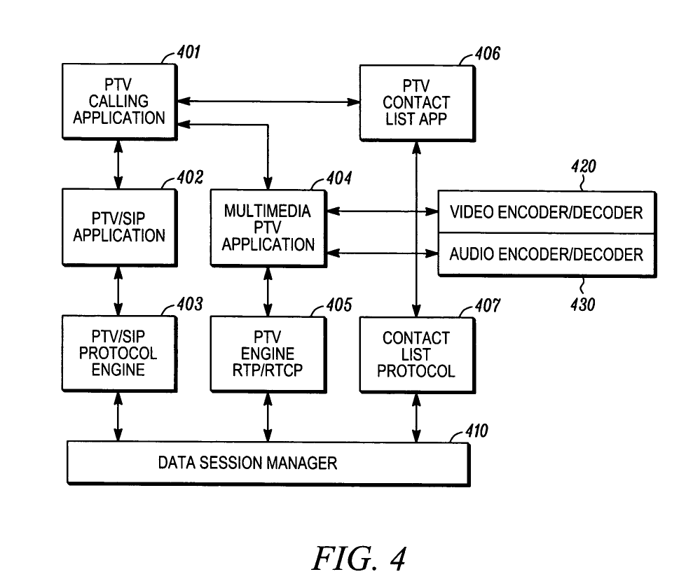

It will be appreciated that in the device 301, PTV calling can be conducted for example in accordance with the diagram shown in FIG. 4. A PTV calling application 401, such as a software program, instructions or the like executing on a processor associated with the originating communication unit such as, for example, the device 301 and the processor 310 thereof. The PTV calling application 401 can be configured to monitor the activation, through for example a hardware or a software initiated interrupt routine or the like, of a PTV activation device or the execution of a routine such as a voice activation routine, and begin operation once PTV activation is detected. A PTV SIP application 402 can transform high level PTV functions generated by the PTV calling application 401, such as PTV activation, into an interim routine which is responsible, for example, for conducting and monitoring the progress of SIP related actions. A PTV SIP protocol engine 403 can be used to generate outbound SIP messages such as SIP INVITE messages for targeted users.

The PTV SIP protocol engine 403 may also handle incoming SIP messages such as SIP 200 OK messages and inform the PTV SIP application 402 whereupon the PTV calling application 401 can be informed and take appropriate action such as generating an indication on a user interface that a particular party has joined the call. Both inbound and outbound SIP messages can be routed through data session manager 410 which can be configured to control the session at the lower layers such as the data link layer physical layer and the like and further can pass messages from the air interface back and forth. It will be appreciated by one of ordinary skill in the art that the interfaces between various modules described in relation to FIG. 4 exist as software interfaces taking the form, for example, of function calls and the like, or may take the form of real time interrupt processing, or other software related processing. Alternatively, the functionality and interfaces may exist in hardware, or may be a combination of hardware and software.

In order to provide audio and video to the PTV application 401 which has the task of displaying the video information and playing the audio information to a user, a multimedia PTV engine 404 is provided to route decoded audio and video information to the PTV application 401 and route audio and video information from the PTV application 401 obtained from various device interfaces such as a camera and microphone to the multimedia PTV engine 404. A video encoder/decoder 420 and an audio encoder/decoder 430 can be provided to encode raw audio and video information obtained, for example, from the PTV application 401 as noted, for transmission in the audio and video media streams. Audio and video codecs or programs conforming to codec standards can be used in the video encoder/decoder 420 and the audio encoder/decoder 430 to allow conformance with appropriate standards associated with, for example, the network over which the information will be transferred. In accordance with various exemplary embodiments, the audio codec can be an Adaptive Multi-Rate (AMR) speech codec and the video codec can be a Moving Picture Experts Group version-4 (MPEG-4) video codec.

In accordance with various exemplary embodiments, the following streams or application flows should be supported to establish audio and video media paths. As noted, SIP signaling is used for multimedia session control and SIP/SDP over UDP/IP for application control between the originating and target UEs and the application servers. A Voice/Video media payload can be carried over RTP/UDP/IP between originating and target UEs and the application server or servers. RTCP over UDP/IP can be used for media control and floor control between UEs and the application server or servers.

As noted above, for example in connection with FIG. 1, there are five distinctively different application flows needed to support PTV in accordance with various exemplary embodiments. Each media needs an RTP data path such as the video media stream 102 and the audio media stream 103 for transporting the respective media payloads and a RTCP data path such as audio control path 104 for transporting the associated media control. A separate data path such as 101 is provided for signaling and control.

The audio media stream 103 carries AMR encoded RTP speech bursts and can also carry DTMF (dual tone multi frequency), SID (silence descriptor) and DTX (Discontinuous transmission) packets. The overall packets for audio flow are AMR/RTP/UDP/IP. A typical bandwidth requirement for an AMR-encoded audio payload is 12.2 Kbps. The audio media stream 103 can consist of fixed packets having a size of 72 bytes including uncompressed RTP/UDP/IP header every 20 ms, for AMR encoded speech with a maximum bandwidth of 12.2 kbps.

The video media stream 102 carries MPEG-4 or H.263 encoded RTP packets. Real time conversational bi-directional streaming class QoS will be required. The video media stream 102 can consists of fixed packets having a size of 72 bytes including uncompressed RTP/UDP/IP header up to 7 fps (frames per second), for MPEG-4 or H.263 encoded stream with a bandwidth of 38 to 42 kbps.

The audio control path 104 consists of RTCP packets carried over UDP/IP and containing media control information for audio and video streams on a separate data path. Each RTP media channel can have an associated RTCP control channel which carries different packet types such as sender and receiver reports for quality feedback, and RTCP APP messages (application specific payload) for carrying floor control information. The RTCP control channel characteristics include variable packets with a size no longer than corresponding RTP packets, and intermittent message transfer. The bandwidth for the RTCP control channel can be 5% of the total bandwidth for RTP/RTCP flow.

The PTV bearer requirements involve an exemplary radio access network providing bearers to transport the application flows noted above. The bearer requirements to support the PTV services described herein are consistent with the Application Level Signaling specified in TS 23.228 section 4.2.6 and PoC Specification section 8.1. An interactive traffic class with highest priority should be used for SIP/SDP signaling bearer with a primary PDP (Packet Data Protocol) context. For the audio media stream 103, assuming the exemplary radio access network supports the streaming class and the local policy allows its usage, then a primary or secondary PDP context with streaming class should be used to carry speech bursts in AMR/RTP/UDP/IP packets. The same PDP context and hence the same bearer should be used to multiplex the associated audio control flow over RTCP/UDP/IP. It should be noted that if the radio access network does not support the streaming class or the usage is subject to local policy, then a PDP context with an interactive class with highest priority should be used to carry speech burst in AMR/RTP/UDP/IP packets. The same PDP context and hence the same bearer should be used to multiplex the associated audio control flow over RTCP/UDP/IP. For the video media stream 102, assuming the exemplary radio access network supports the streaming class and the local policy allows its usage, then either a primary or a secondary PDP context with streaming class should be used to carry the video stream on H.263 or MPEG4/RTP/UDP/IP packets. The same PDP context and hence the same bearer should be used to multiplex the associated video control flow over RTCP/UDP/IP. If the radio access network does not support the streaming class or the usage is subject to local policy, then a PDP context with an interactive class with highest priority should be used to carry the video stream over H.263 or MPEG4/RTP/UDP/IP packets.

Further in accordance with various exemplary embodiments, several permutations of PDP contexts are possible. Where separate PDP contexts with streaming class for media and interactive class for signaling are used, the PDP context for signaling should be on primary, and the PDP context for media can be either on primary or secondary. Where one PDP context with streaming class for media and another PDP context with interactive class for signaling is used, the PDP context for signaling should be primary and the PDP context for media can be either on primary or secondary. Where separate PDP contexts with interactive class for media and signaling are used, the PDP context for signaling should be on primary and the PDP context for media can be either on primary or secondary. Where one PDP context with interactive class for media and another PDP context with interactive class for signaling is used, the PDP context for signaling should be primary and the PDP context for media can be either on primary or secondary. Lastly, a protocol architecture for RTP/RTCP and SIP multiplexing can include one primary PDP context with interactive class for media and signaling.

The multimedia PTV engine 404 can pass raw information to a video encoder/decoder 420 and an audio encoder/decoder 430 and receive corresponding encoded information streams which can be passed down to a PTV Real Time Transfer Protocol (RTP)/Real Time Transfer Control Protocol (RTCP) engine 405 for packaging and controlling the transfer of the audio and video streams over the air interface. It will be appreciated that while in the figure, several elements are drawn “below” each other, the elements in FIG. 4, with the exception of data session manager 410, can be considered as being associated with the application layer typically described in connection with the Open Systems Interconnect (OSI) seven layer protocol stack. As streams are received from, for example, the PTV RTP/RTCP engine 405, they can be further controlled by the data session manager 410. The video encoder/decoder 420 and the audio encoder/decoder 430 can further process inbound information streams received by the RTP/RTCP engine 405 from the data session manger 410. It is important to note that since video media streams are always on in a full duplex mode, no floor control is required for the video stream and thus no RTCP control path is required resulting in a path savings. It should be noted that with regard to the video encoder/decoder 420, raw data streams such as from a microphone and a video camera are encoded in the supported media format before being transferred to the application server. As noted, multimedia formats can be negotiated during session initiation, for example, during a SIP offer SDP answer exchange. Encoded data can be transferred to its destination in accordance with RTP and the incoming data streams can be decoded in the supported format and passed to the receiving device for playing and display. Since audio media streams are established in half duplex mode, an RTP path is required for media transport and an RTCP control path is required for control transport.

In order to establish a call with a target communication unit, the PTV calling application 401 must provide an address, for example in a SIP INVITE message. A PTV contact list application 406 can keep track of addresses of potential targets both through data entry by the user, by loading of list information over the air interface, by storing information associated with an incoming call, or the like in a manner which will be understood by those of ordinary skill in the art. In the case where contact list information is obtained over the air interface, the data session manager 410 can extract contact list information such as addresses from the air interface and pass the information to a contact list protocol engine 407 which in turn can update contact list information or provide information for contact list updating to the PTV contact list application 406.

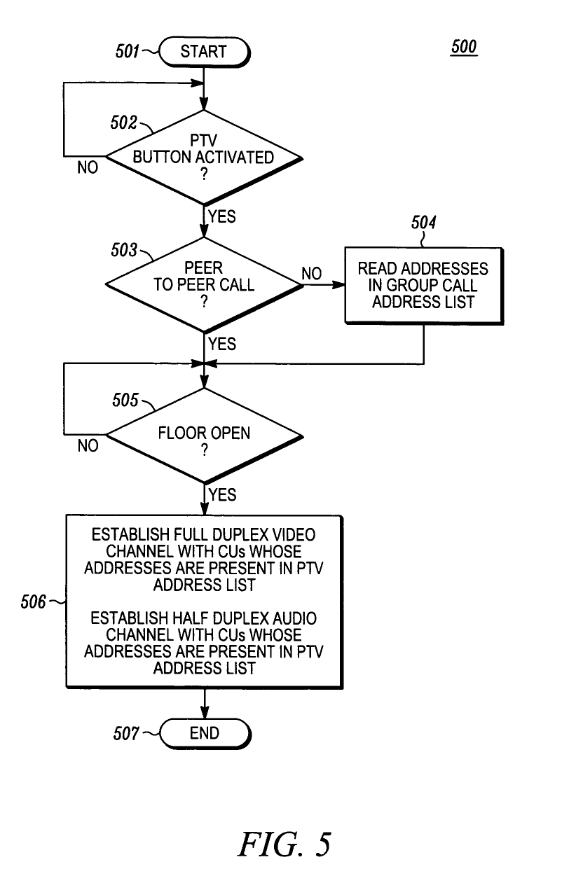

It will be appreciated from the above discussion that many of the features of the present invention are susceptible to being implemented in a software program such as an application program or in a series of intercommunicating software programs, application, routines, modules, operating systems and the like. In addition, much of the functionality can be conducted as a method or procedure with a series of steps or the like. An exemplary procedure 500 is shown in FIG. 5, and begins at start 501. During operation of, for example, the exemplary originating device, which as will be appreciated can at one time or another be any of the communication units involved in the peer to peer or group calls described herein above, a continuous test can be made to determine whether a PTV button, activator or the like has been pressed at 502. Alternatively, an interrupt can be generated when the button or activator is pressed or activated at which point activation will be deemed to have occurred.

Once activation has occurred, it can be determined at 503 whether the call is a peer-to-peer or group call for the purposes of determining whether a contact or address list must be consulted. If the call is a peer to peer call, it can be determined at 505 as to whether the floor is open, for example through the issuing by the system of a Talk Permit Tone as described herein above. Alternatively, it will be appreciated that a peer-to-peer call can be considered a subset of a group call where there is only one contact in the contact list. Thus, if the call is considered a group call, the addresses from a contact list can be read at 504 and, again, it can be determined whether the floor is open at 505. If the floor is open, a full duplex video channel can be opened at 506 to facilitate a video stream or a video portion of a multimedia stream between the originating communication unit and the one or more target communication units associated with the peer to peer or group call, for example as notified using a SIP INVITE message in accordance with the addresses listed in the contact list or in the peer-to-peer contact information. A half duplex audio channel may also be established at 506 to facilitate an audio stream or audio portion of a multimedia stream between the originating communication unit and the one or more target communication units associated with the peer to peer or group call, for example as notified using the SIP INVITE message at noted above. The method of FIG. 5 ends at 507 but may be repeated as needed.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method for transmitting a video information stream and a corresponding audio information stream from an originating communication unit having floor control to a target communication unit, the method comprising:
initiating a call from the originating communication unit to the target communication unit to obtain the floor control; and
establishing a media path between the originating communication unit and the target communication unit for transferring the video information stream and the audio information stream between the originating communication unit and the target communication unit.

2. A method in accordance with claim 1, wherein the video information stream is established in a full duplex mode and the audio information stream is established in a half duplex mode.

3. A method in accordance with claim 1, wherein at least one of the initiating the call and the establishing the media path includes using a Session Initiation Protocol (SIP).

4. A method in accordance with claim 1, wherein at least one of the originating communication unit and the target communication unit includes a wireless communication unit.

5. A method in accordance with claim 1, wherein:
the call includes a group call;
the initiating the call includes initiating the group call from the originating communication unit to the target communication unit and an additional target communication unit; and
the establishing the media path includes establishing the media path between the originating communication unit, the target communication unit, and the additional target communication unit for transferring the video information stream and the audio information stream between the originating communication unit, the target communication unit, and the additional target communication unit.

6. A method in accordance with claim 5, wherein at least one of the initiating the call and the establishing the media path includes using a Session Initiation Protocol (SIP.

7. A method in accordance with claim 5, wherein at least one of the originating communication unit, the target communication unit, and the additional target communication unit includes a wireless communication unit.

8. A method in accordance with claim 5, wherein the video information stream is established in a full duplex mode and the audio information stream is established in a half duplex mode.

9. A method for transmitting a video information stream and a corresponding audio information stream from an originating communication unit to a target communication unit, the method comprising:
initiating a call using a Session Initiation Protocol (SIP) from the originating communication unit to the target communication unit; and
establishing a media path between the originating communication unit and the target communication unit using the SIP protocol, the media path for transferring the video information stream and the audio information stream between the originating communication unit and the target communication unit.

10. A method in accordance with claim 9, wherein the video information stream is established in a full duplex mode and the audio information stream is established in a half duplex mode.

11. A method in accordance with claim 9, wherein at least one of the originating communication unit and the target communication unit includes a wireless communication unit.

12. A method in accordance with claim 9, wherein the initiating the call includes activating a Push To Video (PTV) activator associated with the originating communication unit to obtain floor control.

13. A method in accordance with claim 9, wherein:
the call includes a group call;
the initiating the call includes initiating the group call from the originating communication unit to the target communication unit and an additional target communication unit using the SIP protocol; and
the establishing the media path includes establishing the media path between the originating communication unit, the target communication unit, and the additional target communication unit using the SIP protocol, the media path for transferring the video information stream and the audio information stream between the originating communication unit, the target communication unit, and the additional target communication unit.

14. A method in accordance with claim 9, wherein:
the call includes a mixed mode group call;
the initiating the call includes initiating the mixed mode group call from the originating communication unit to the target communication unit and an additional target communication unit using the SIP protocol; and
the establishing the media path includes establishing the media path between the originating communication unit, and at least one of the target communication unit and the additional target communication unit using the SIP protocol, the media path for transferring the video information stream and the audio information stream between the originating communication unit, and the at least one of the target communication unit and the additional target communication unit,
wherein at least one other of the target communication unit, and the additional target communication unit can be configured to receive only the audio information stream.

15. A method in accordance with claim 13, wherein the video information stream is established in a full duplex mode and the audio information stream is established in a half duplex mode.

16. A method in accordance with claim 13, wherein at least one of the originating communication unit, the target communication unit, and the additional target communication unit includes a wireless communication unit.

17. An apparatus capable of transmitting a video information stream and a corresponding audio information stream to a target communication unit in a Radio Access Network (RAN), the apparatus comprising:
a RAN interface;
a memory; and
a processor coupled to the memory and the RAN interface, the processor configured to:
initiate a call to the target communication unit when an activation event is detected; and
establish a media path with the target communication unit over the RAN interface so as to transfer the video information stream in a full duplex mode to the target communication unit and so as to transfer the audio information stream in a half duplex mode to the target communication unit.

18. An apparatus in accordance with claim 17, wherein the activation event includes a Push To Video (PTV) activating event to obtain floor control.

19. An apparatus in accordance with claim 17, wherein the call includes a group call, and wherein the processor:
in initiating the call is further configured to initiate the group call to the target communication unit and an additional target communication unit using a session initiation protocol (SIP) protocol when the activating event is detected; and
in establishing the media path is further configured to establish the media path with the target communication unit, and the additional target communication unit over the RAN interface using the SIP protocol, the media path for transferring the video information stream in the full duplex mode and the audio information stream in the half duplex mode to the target communication unit, and the additional target communication unit.

20. An apparatus in accordance with claim 19, further comprising a wireless communication unit.
